(19) United States
(12) Patent Application Publication
(10) Pub. No.: US 2025/0218230 A1
(43) Pub. Date: Jul. 3, 2025

(54) INFORMATION PROCESSING APPARATUS AND METHOD FOR IMPROVING TRAVEL MAAS

(71) Applicant: TOYOTA JIDOSHA KABUSHIKI KAISHA, Toyota-shi (JP)

(72) Inventor: Hiroki TAKEISHI, Tokyo-to (JP)

(73) Assignee: TOYOTA JIDOSHA KABUSHIKI KAISHA, Toyota-shi (JP)

(21) Appl. No.: 19/001,480

(22) Filed: Dec. 25, 2024

(30) Foreign Application Priority Data
Dec. 28, 2023 (JP) 2023-223203

(51) Int. Cl. G07C 5/04; G06Q 50/40

(52) U.S. Cl. CPC G07C 5/04; G06Q 50/40

(57) ABSTRACT

An information processing apparatus includes a controller. The controller is configured to acquire vehicle data including positional information for a vehicle, and data on a usage status of the vehicle in an operation of each of a plurality of drivers. The controller is configured to generate a plurality of pieces of trip data for the vehicle based on the vehicle data. The trip data is data on a travel history of the vehicle from a departure point to a destination. The controller is configured to associate each of the plurality of pieces of the trip data with each of the plurality of drivers based on the data on the usage status of the vehicle.

### CROSS-REFERENCE TO RELATED APPLICATION

This application claims priority to Japanese Patent Application No. 2023-223203 filed on Dec. 28, 2023, the entire contents of which are incorporated herein by reference.

### TECHNICAL FIELD

The present disclosure relates to an information processing apparatus and a method for improving travel MaaS.

### BACKGROUND

A system that generates data on daily driving reports of trucks transporting cargo is known. See Patent Literature (PTL) 1.

### CITATION LIST

### Patent Literature

PTL 1: JP 2010-152668 A

### SUMMARY

In operations, the same vehicle may be driven by a plurality of drivers. In this case, the correspondence between each of the plurality of pieces of trip data for the vehicle and each of the plurality of drivers is unclear in the conventional technology.

It would be helpful to clarify the correspondence between each of a plurality of pieces of trip data for a vehicle and each of a plurality of drivers.

An information processing apparatus according to an embodiment of the present disclosure includes a controller configured to acquire vehicle data including positional information for a vehicle, and data on a usage status of the vehicle in an operation of each of a plurality of drivers. The controller is configured to generate a plurality of pieces of trip data for the vehicle based on the vehicle data. The trip data is data on a travel history of the vehicle from a departure point to a destination. The controller is configured to associate each of the plurality of pieces of the trip data with each of the plurality of drivers based on the data on the usage status of the vehicle.

A method, by a processor, for improving travel mobility as a service (MaaS) according to an embodiment of the present disclosure includes processing steps executed by the information processing apparatus.

According to an embodiment of the present disclosure, the correspondence between each of a plurality of pieces of trip data for a vehicle and each of a plurality of drivers can be clarified.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a sequence diagram illustrating an example of a processing procedure of the system illustrated in FIG. 1;

FIG. 3 is a diagram illustrating an example of vehicle data;

FIG. 4 is a diagram illustrating a process of associating a plurality of pieces of trip data with a plurality of drivers; and

FIG. 5 is a diagram illustrating data on schedule lists for the drivers and the trip data.

### DETAILED DESCRIPTION

An embodiment of the present disclosure will be described below, with reference to the drawings.

### Configuration of System

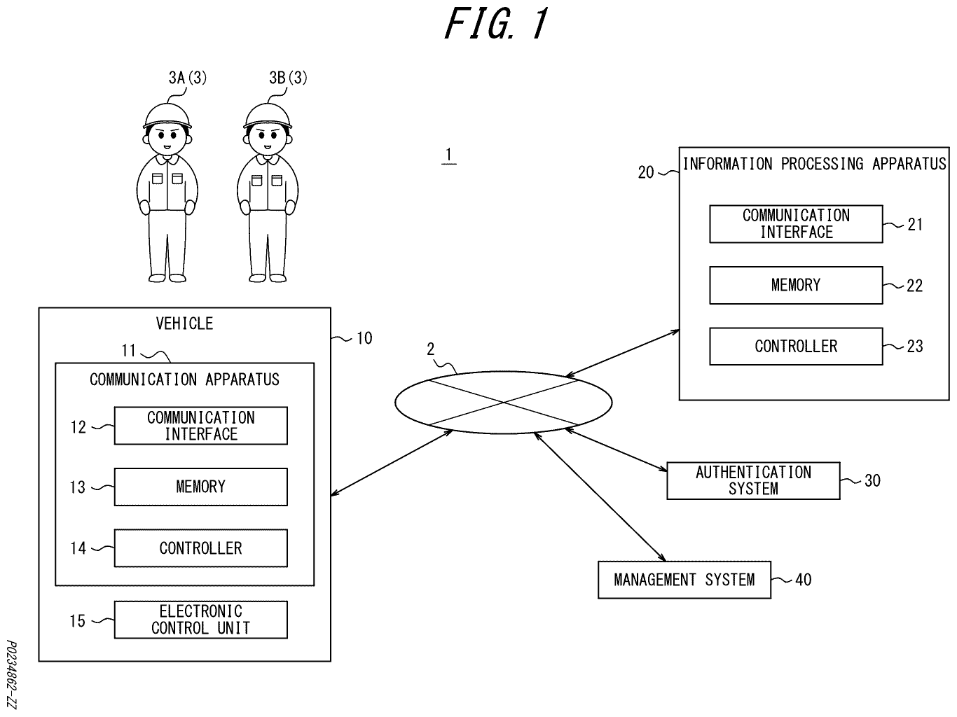

As illustrated in FIG. 1, a system 1 for the present embodiment includes a vehicle 10, an information processing apparatus 20, an authentication system 30, and a management system 40. In the present embodiment, the number of vehicles 10 included in the system 1 is one. However, the number of vehicles 10 included in the system 1 may be two or more.

The vehicle 10, the information processing apparatus 20, the authentication system 30, and the management system 40 are communicable via a network 2. The network 2 may be any network including a mobile communication network, the Internet, or the like.

The vehicle 10 is a shared vehicle used for operations. The operations in which the vehicle 10 is used are, for example, transportation or sales. The vehicle 10 may be an automobile used by the company, i.e., a so-called company car. The vehicle 10 may be any type of automobile. For example, the vehicle 10 may be a cargo automobile or a standard automobile.

The vehicle 10 is driven by a driver 3. In the present embodiment, the driver 3 driving the vehicle 10 includes a driver 3A and a driver 3B. However, the driver 3 driving the vehicle 10 may include any number of drivers.

The information processing apparatus 20 generates a plurality of pieces of trip data for the vehicle 10, as described below. The information processing apparatus 20 also acquires data on the usage status of the vehicle 10, which indicates the usage status of the vehicle 10 in an operation of each of the plurality of drivers 3. The data on the usage status of the vehicle 10 may be any data that indicates the usage status of the vehicle 10 in the operation of each of the plurality of drivers 3. The following is an example of data on the usage status of the vehicle 10.

As an example, the data on the usage status of the vehicle 10 may include at least any of the following: the driving operation start time when the driver 3 starts the driving operation and the driving operation end time when the driver 3 ends the driving operation. At least any of the driving operation start time and the driving operation end time will give an indication of the usage status of the vehicle 10 by the driver 3. Therefore, the driving operation start time and the driving operation end time can be included in the data on the usage status of the vehicle 10.

As another example, data on the usage status of the vehicle 10 may include data on a schedule list for the driver 3. The data on the schedule list for the driver 3 includes, for example, data on the details of the operation of the driver 3, the date on which the operation of the driver 3 is scheduled, the start and end times of the operation of the driver 3, and the data on the means of transportation in the operation. The data on the means of transportation of the driver 3 includes the data on the reservation slots for the vehicle 10. The reservation slots for the vehicle 10 include the date on which the vehicle 10 is scheduled to be used and the time period from the scheduled start time until the scheduled end time of the use of the vehicle 10. The data on the schedule list for the driver 3 provides information on the usage status of the vehicle 10 in the operation of the driver 3. Thus, the data on the schedule list for the driver 3 can be included in the data on the usage status of the vehicle 10.

As yet another example, the data on the usage status of the vehicle 10 may include data on a reservation list for the vehicle 10. The data on the reservation list for the vehicle 10 includes data on the reservation slots for the vehicle 10 and information on the driver 3 who reserved those slots.

The information processing apparatus 20 associates each of the generated plurality of pieces of the trip data for the vehicle 10 with each of the plurality of drivers 3 based on the acquired data on the usage status of the vehicle 10. This configuration allows for a clear correspondence between each of the plurality of pieces of trip data for the vehicle 10 and each of the plurality of drivers 3.

The information processing apparatus 20 is a dedicated computer configured to function as a server, a general purpose personal computer, a cloud computing system, or the like.

The authentication system 30 is used to authenticate the driver 3. The authentication system 30 is, for example, configured to include an authentication apparatus and a control apparatus. The control apparatus includes, for example, a communication interface with the same or similar configuration as the communication interface 12 or 21 described below, a memory with the same or similar configuration as the memory 13 described below, and a controller with the same or similar configuration as the controller 14 described below. Authentication apparatuses are, for example, alcohol checkers, driver's license readers or employee ID card readers. The information acquired by such an authentication apparatus can be used to identify at least any of the driving operation start time for the driver 3 and the driving operation end time for the driver 3, as explained below.

For example, if the vehicle 10 is used for an operation, the driver 3 may be required to perform an alcohol checker before the driver 3 starts driving the vehicle 10. In this case, the alcohol checker, which is a recognition apparatus, can acquire the time of use of the alcohol checker by the driver 3. The time of use of the alcohol checker by the driver 3 can be used to identify the driving operation start time for the driver 3. In the authentication system 30, the control apparatus may transmit the time of use of the alcohol checker by the driver 3 acquired by the authenticator to the information processing apparatus 20 via the network 2 as the driving operation start time for the driver 3.

For example, if the vehicle 10 is used for an operation, the driver 3 may be required to touch the driver's license with an embedded IC chip to the reader before the driver 3 starts driving the vehicle 10. In this case, the license reader, which is an authentication apparatus, can acquire the time when the driver 3 touched his/her driver's license to the license reader. The time when the driver 3 touched his/her driver's license to the license reader can be used to identify the driving operation start time for the driver 3. It may also require the driver 3 to touch his/her driver's license to the license reader after the driver 3 has ended his/her driving operation of the vehicle 10. In this case, the license reader, which is an authentication apparatus, can acquire the time when the driver 3 touched his/her driver's license to the license reader. The time when the driver 3 touched his/her driver's license to the license reader can be used to identify the operation end time for the driver 3. In the authentication system 30, the control apparatus may transmit the time when the driver 3 touched his/her driver's license to the license reader, acquired by the authentication apparatus, to the information processing apparatus 20 via the network 2 as the driving operation start time or the driving operation end time for the driver 3.

For example, the vehicle 10 may be waiting in a parking lot or other waiting area when not in use. An employee ID reader may also be placed at the gate of the waiting area. In this case, the driver 3 drives the vehicle 10 out of the gate of the waiting area when he/she starts his/her driving operation of the vehicle 10. In addition, the driver 3 holds his/her employee ID card over the employee ID reader as he/she exits the gate of the waiting area. Thus, the employee ID card reader, which is an authentication apparatus, can acquire the time when the driver 3 held his/her employee ID card over the employee ID card reader. The time when the driver 3 held his/her employee ID card over the employee ID reader can be used to identify the driving operation start time for the driver 3. When the driver 3 ends his/her driving operation of the vehicle 10, he/she drives the vehicle 10 into the gate of the waiting area. In addition, the driver 3 holds his/her employee ID card over the employee ID reader when entering the gate of the waiting area. Thus, the employee ID card reader, which is an authentication apparatus, can acquire the time when the driver 3 held his/her employee ID card over the employee ID card reader. The time when the driver 3 held his/her employee ID card over the employee ID reader can be used to identify the driving operation end time for the driver 3. In the authentication system 30, the control apparatus may transmit the time when the driver 3 held his/her employee ID card over the employee ID reader, acquired by the authentication apparatus, to the information processing apparatus 20 via the network 2 as the driving operation start time or the driving operation end time for the driver 3.

The management system 40 is a system for managing the details of the operation of the driver 3. The management system 40 is, for example, configured to include a management apparatus and a control apparatus. The control apparatus includes, for example, a communication interface with the same or similar configuration as the communication interface 12 or 21 described below, a memory with the same or similar configuration as the memory 13 described below, and a controller with the same or similar configuration as the controller 14 described below. The management apparatus maintains a schedule list for the driver 3 and a schedule list for the vehicle 10. In the management system 40, the control apparatus may transmit at least any of the data on the schedule list for the driver 3 and the reservation list for the vehicle 10 to the information processing apparatus 20 via the network 2.

### Configuration of Vehicle

The vehicle 10 includes a communication apparatus 11 and an electronic control unit 15. The communication apparatus 11 and the electronic control unit 15 can communicate via an in-vehicle network, such as a Controller Area Network (CAN), or a dedicated line. The communication apparatus 11 includes a communication interface 12, a memory 13, and a controller 14.

The communication interface 12 is configured to include at least one communication module for connection to the network 2. The communication module is a communication module compliant with a mobile communication standard such as Long Term Evolution (LTE), 4th Generation (4G), or 5th Generation (5G).

The memory 13 is configured to include at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM), dynamic random access memory (DRAM), or the like. The ROM is, for example, Electrically Erasable Programmable Read Only Memory (EEPROM) or the like. The memory 13 may function as a main memory, an auxiliary memory, or a cache memory. The memory 13 stores data to be used for the operations of the communication apparatus 11 and data obtained by the operations of the communication apparatus 11. The memory 13 may store any program to be used for operations of the communication apparatus 11. For example, the memory 13 stores a system program, an application program, and/or embedded software.

The controller 14 is configured to include at least one processor, at least one dedicated circuit, or a combination thereof. The processor is, for example, a general purpose processor such as a Central Processing Unit (CPU) or a Graphics Processing Unit (GPU), or a dedicated processor that is dedicated to a specific process. Examples of dedicated circuits can include a Field-Programmable Gate Array (FPGA) and an Application Specific Integrated Circuit (ASIC). The controller 14 executes processes related to the operations of the vehicle 10 while controlling components of the vehicle 10.

The electronic control unit 15 is an Electronic Control Unit (ECU) of the vehicle 10. The electronic control unit 15 controls various functions of the vehicle 10.

### Configuration of Information Processing Apparatus

The information processing apparatus 20 includes a communication interface 21, a memory 22, and a controller 23.

The communication interface 21 is configured to include at least one communication module for connection to the network 2. For example, the communication module is a communication module compliant with a standard such as a wired Local Area Network (LAN) or a wireless LAN. The communication interface 21 is connectable to the network 2 via a wired LAN or a wireless LAN using the communication module.

The memory 22 is configured to include at least one semiconductor memory, at least one magnetic memory, at least one optical memory, or a combination of at least two of these. The configuration of the memory 22 may be the same or similar to the configuration of the memory 13. The memory 22 may function as a main memory, an auxiliary memory, or a cache memory. The memory 22 stores data to be used in the operations of the information processing apparatus 20 and data obtained by the operations of the information processing apparatus 20. The memory 22 may store any program to be used for operations of the information processing apparatus 20. For example, the memory 22 stores a system program, an application program, and/or embedded software.

The controller 23 is configured to include at least one processor, at least one dedicated circuit, or a combination thereof. The configuration of the controller 23 may be the same or similar to that of the controller 14. The controller 23 executes processes related to the operations of the information processing apparatus 20 while controlling components of the information processing apparatus 20.

### Operations of System

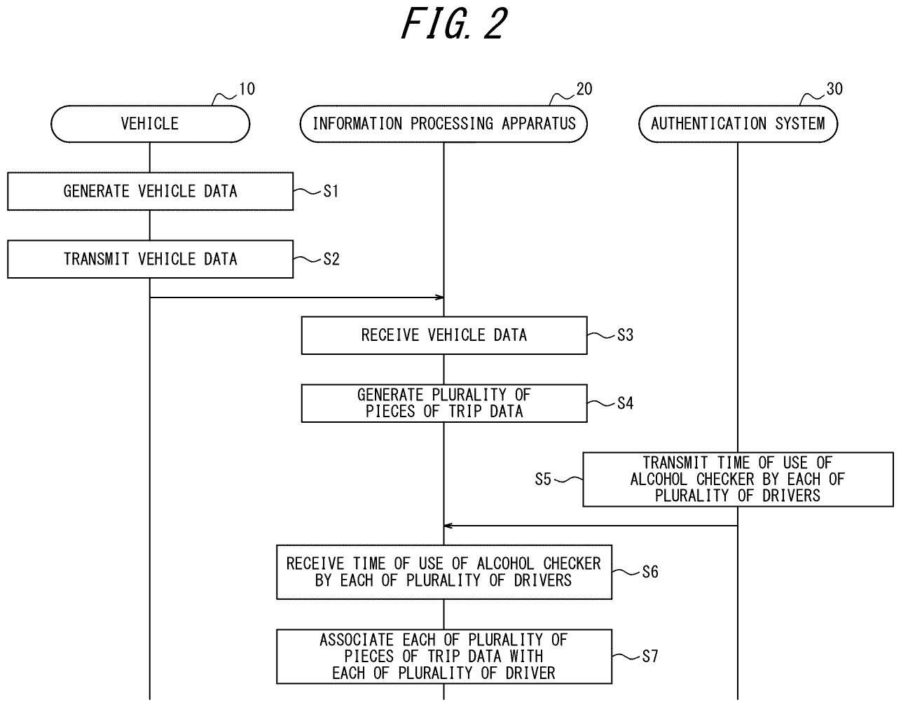

FIG. 2 is a sequence diagram illustrating an example of a processing procedure of the system 1 illustrated in FIG. 1. In FIG. 2, the data on the usage status of the vehicle 10 is assumed to be the driving operation start time for the driver 3.

The process of S1 is performed by the electronic control unit 15 of the vehicle 10. The electronic control unit 15 generates vehicle data. The vehicle data includes positional information for the vehicle 10. The vehicle data may include a plurality of pieces of positional information for the vehicle 10. The plurality of pieces of the positional information for the vehicle 10 can be data for the operational trajectory of the vehicle 10. In the present embodiment, the vehicle data includes a plurality of times, positional information for the vehicle 10 at each of the plurality of times, and information indicating whether the ignition of the vehicle 10 is on or off at each of the plurality of times. The vehicle data may further include historical data on the driving operation of the vehicle 10. The historical data on the driving operation of the vehicle 10 includes, for example, historical data on the speed of the vehicle 10. The vehicle data may include any data required in the daily driving reports.

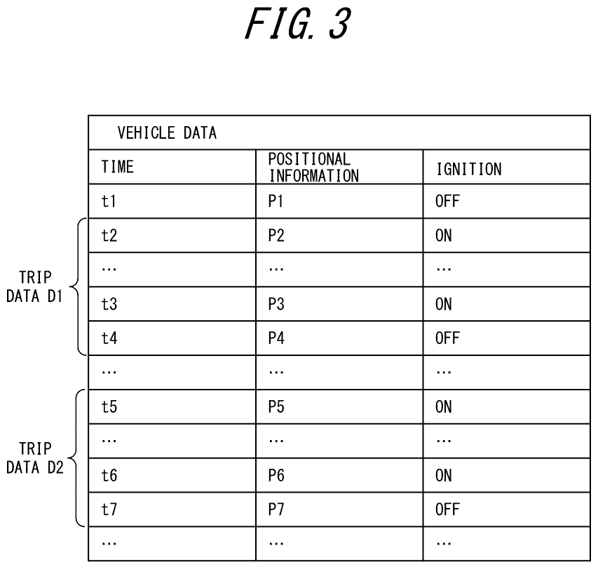

For example, the electronic control unit 15 generates vehicle data as illustrated in FIG. 3. This vehicle data includes the positional information P1 to P7 for the vehicle 10 at each of times t1 to t7. The vehicle data also includes information indicating whether the ignition of the vehicle 10 is on or off at each of the times t1 to t7.

In the process of S2, the controller 14 of the communication apparatus 11 controls the communication interface 12 to transmit the vehicle data generated in the process of S1 to the information processing apparatus 20 via the network 2.

In the process of S3, the controller 23 of the information processing apparatus 20 controls the communication interface 21 to receive the vehicle data from the vehicle 10 via the network 2. In the present embodiment, the controller 23 acquires vehicle data by receiving the vehicle data.

In the process of S4, the controller 23 generates a plurality of pieces of trip data based on the vehicle data. The trip data for the vehicle 10 is data on a travel history of the vehicle 10 from a departure point to a destination. The trip data for the vehicle 10 may include the time at which the vehicle 10 departs from the departure point and the time at which the vehicle 10 reaches the destination. Here, the driver 3 turns on the ignition of the vehicle 10 before leaving for the departure point by the vehicle 10. The driver 3 also turns off the ignition of the vehicle 10 when the vehicle 10 reaches the destination. Therefore, the controller 23 generates one trip data by the positional information for the vehicle 10 from the time the ignition of the vehicle 10 is turned on until it is turned off.

For example, in FIG. 3, the ignition of the vehicle 10 is turned on at a time t2. At a time t4, the ignition of the vehicle 10 is turned off. Therefore, the controller 23 generates the trip data D1 by the positional information P2 to the positional information P4 from the time t2 to the time t4. At a time t5, the ignition of the vehicle 10 is turned on. At a time t7, the ignition of the vehicle 10 is turned off. Therefore, the controller 23 generates the trip data D2 by the positional information P5 to the positional information P7 from the time t5 to the time t7.

In the process of S5, the authentication system 30 transmits the time of use of the alcohol checker by each of the plurality of drivers 3 to the information processing apparatus 20 via the network 2 as the driving operation start time for each of the plurality of drivers 3.

In the process of S6, the controller 23 of the information processing apparatus 20 receives the time of use of the alcohol checker by each of the plurality of drivers 3 from the authentication system 30 via the network 2, as the driving operation start time for each of the plurality of drivers 3 by the communication interface 21.

In the process of S7, the controller 23 associates each of the plurality of pieces of the trip data generated in the process of S4 with each of the plurality of drivers 3, based on the driving operation start time for each of the plurality of drivers 3 acquired in the process of S6. As an example, the controller 23 associates the trip data for a time period from a driving operation start time for a predetermined driver 3 among a plurality of drivers 3 until a driving operation start time for the next driver 3 to the predetermined driver 3 with the predetermined driver 3. The next driver 3 to the predetermined driver 3 is the driver who drove the vehicle 10 after the predetermined driver 3.

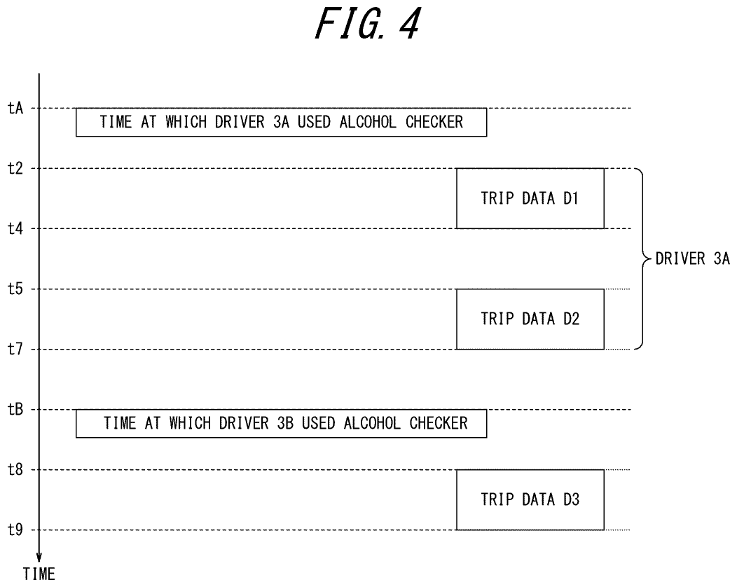

For example, in FIG. 4, the controller 23 receives a time tA as the time of use of the alcohol checker by the driver 3A, i.e., the driving operation start time for the driver 3A. The time tA is earlier than the time t2. The controller 23 receives a time tB as the time of use of the alcohol checker by the driver 3B, i.e., the driving operation start time for the driver 3B. The time tB is later than the time t7 and earlier than a time t8. The controller 23 associates the trip data D1 and D2 for the time period from the time tA, which is the driving operation start time for the driver 3A, until the time tB, which is the driving operation start time for the next driver 3B to the driver 3A, with the driver 3A.

In the process of S7, the controller 23 may generate the data on daily driving reports upon associating each of the plurality of pieces of the trip data with each of the plurality of drivers 3. The data on the daily driving reports includes the plurality of pieces of the trip data with which each of the plurality of drivers 3 is associated, and data on the travel distance in the plurality of pieces of the trip data. However, the data on the daily driving reports may include any data.

Thus, in the information processing apparatus 20 according to the present embodiment, the controller 23 associates each of the plurality of pieces of trip data with each of the plurality of drivers 3, based on the data of the usage status of the vehicle 10. This configuration allows for a clear correspondence between each of the plurality of pieces of trip data for the vehicle 10 and each of the plurality of drivers.

Furthermore, in the present embodiment, the controller 23 may associate each of the plurality of pieces of the trip data with each of the plurality of drivers 3 based on the driving operation start time for each of the plurality of drivers as data on the usage status of the vehicle 10. Here, when the vehicle 10 is used for an operation, the driver 3 is often required to perform an alcohol checker before the driver 3 starts driving the vehicle 10. In many cases, the driver 3 is required to touch his/her license to the reader before he/she starts driving the vehicle 10. Therefore, the driving operation start time for the driver 3 is relatively easy to be acquired. Therefore, it is relatively easy to associate each of the plurality of pieces of the trip data for the vehicle 10 with each of the plurality of drivers 3 by using driving operation start time for each of the plurality of drivers 3.

The processes from S5 through S7 are not limited to those described above. Alternative examples of the processes from S5 through S7 are described below.

### Alternative Example 1

In an alternative example 1, the driving operation start time and the driving operation end time for each of the plurality of drivers 3 are used as data on the usage status of the vehicle 10. The following is a description of the processes from S5 through S7 according to the alternative example 1.

In the process of S5, the authentication system 30 transmits the times when each of the plurality of drivers 3 touched their driver's license to the license reader to the information processing apparatus 20 as the driving operation start time and the driving operation end time for each of the plurality of drivers 3. Alternatively, the authentication system 30 transmits the times when the plurality of drivers 3 held their employee ID cards over the employee ID reader to the information processing apparatus 20 as the driving operation start time and the driving operation end time for each of the plurality of drivers 3.

In the process of S6, the controller 23 of the information processing apparatus 20 receives from the authentication system 30 the times when each of the plurality of drivers 3 touched their driver's license to the license reader, as the driving operation start time and the driving operation end time for each of the plurality of drivers 3. Alternatively, the controller 23 receives from the authentication system 30 the times when the plurality of drivers 3 held their employee ID cards over the employee ID card reader as the driving operation start time and the driving operation end time for each of the plurality of drivers 3.

In the process of S7, the controller 23 associates each of the plurality of pieces of the trip data with each of the plurality of drivers 3 based on the driving operation start time and the driving operation end time for each of the plurality of drivers 3. As an example, the controller 23 associates the trip data for the time period from the driving operation start time for the driver 3 until the driving operation end time for the driver 3 with the driver 3.

Thus, in the alternative example 1, the controller 23 associates the plurality of pieces of the trip data with each of the plurality of drivers 3 based on the driving operation start time and driving operation end time for each of the plurality of drivers 3. This configuration allows for accurate correspondence between each of the plurality of pieces of trip data for the vehicle 10 with each of the plurality of drivers 3. For example, after the driving operation end time for the driver 3A and before the driving operation start time for the driver 3B, the vehicle 10 may be moved for maintenance, etc. at the waiting area. In this case, the trip data would be generated between the driving operation end time for the driver 3A and the driving operation start time for the driver 3B. The alternative example 1 prevents such trip data from being associated with any of the driver 3A and the driver 3B.

### Alternative Example 2

In an alternative example 2, data on a schedule list for each of the plurality of the drivers 3 is used as data on the usage status of the vehicle 10. The following is a description of the processes from S5 through S7 according to the alternative example 2.

The process of S5 is performed by the management system 40 instead of the authentication system 30. In the process of S5, the management system 40 transmits the data on the schedule list for each of the plurality of drivers 3 to the information processing apparatus 20 via the network 2.

In the process of S6, the controller 23 of the information processing apparatus 20 controls the communication interface 21 to receive the data on the schedule list for each of the plurality of drivers 3 from the management system 40 via the network 2.

In the process of S7, the controller 23 associates each of the plurality of pieces of the trip data generated in the process of S4 with each of the plurality of drivers 3, based on the data on the schedule list for each of the plurality of drivers 3. As mentioned above, the data on the schedule list for the driver 3 includes the data on the details of the operation of the driver 3, the date on which the operation of the driver 3 is scheduled, the start and end times of the operation of the driver 3, and the data on the means of transportation in the operation. As mentioned above, the data on the means of transportation of the driver 3 also includes data on the reservation slots for the vehicle 10. Therefore, the controller 23 may associate the trip data that belongs to the time period of the reservation slots for the vehicle 10 of a predetermined driver 3 among a plurality of pieces of trip data generated in the process of S4 with the predetermined driver 3. However, if the time period of the reservation slots for the vehicle 10 of a predetermined driver 3 includes the start and end times of the operation of another driver 3, the trip data belonging to the time period of the reservation slots for the vehicle 10 of a predetermined driver 3 need not be associated with the predetermined driver 3. In other words, if the time period of the reservation slots for the vehicle 10 of a predetermined driver 3 does not include the start and end times of the operation of another driver 3, the trip data belonging to the time period of the reservation slots for the vehicle 10 of a predetermined driver 3 may be associated with the predetermined driver 3. The controller 23 treats the start and end times of the operation of the driver 3 on the same date as the date of the trip data as the start and end times of the operation of the driver 3. The controller 23 also handles the data on the reservation slots for the vehicle 10 that are scheduled to be used on the same date as the date of the trip data. The trip data date is the date the vehicle 10 performed the trip.

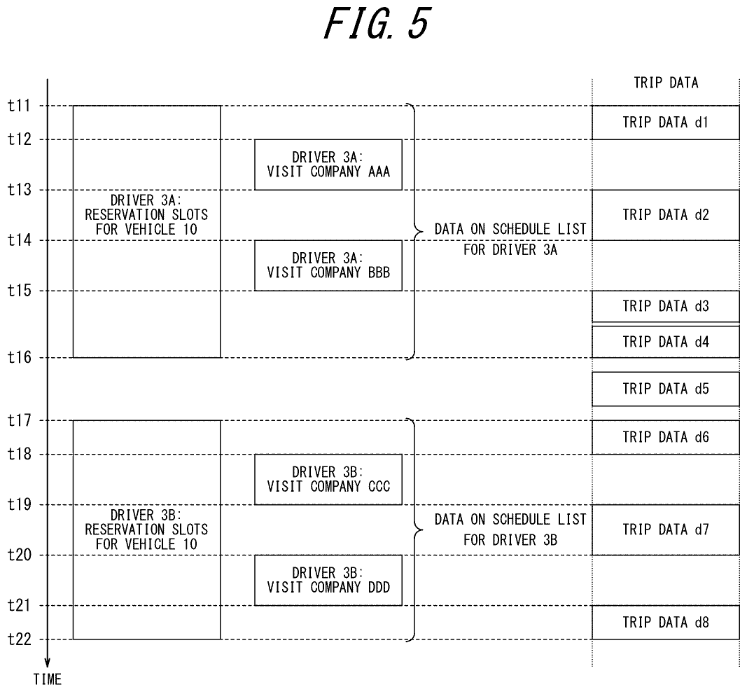

For example, in FIG. 5, the controller 23 generates trip data d1 to d8. The controller 23 also acquires the data on the schedule list for each of the driver 3A and the driver 3B. The data on the schedule list for the driver 3A includes the data on the details of the operation of the driver 3A, i.e., visits to company AAA and visits to company BBB. The data on the schedule list for the driver 3A includes, as the start and end times of the operation of the driver 3A, a time t12, which is the start time of the visit to company AAA, and a time t13, which is the end time of the visit to company AAA, and a time t14, which is the start time of the visit to company BBB, and a time t15, which is the end time of the visit to company BBB. The data on a schedule list for the driver 3A includes the data on the reservation slots for the vehicle 10 from a time t11 to a time t16. The data on a schedule list for the driver 3B includes the data on a visit to company CCC and a visit to company DDD as the data on the details of the operation of the driver 3B. The data on the schedule list for the driver 3B includes, as the start and end times of the operation of the driver 3B, a time t18, which is the start time of the visit to company CCC, and a time t19, which is the end time of the visit to company CCC, and a time t20, which is the start time of the visit to company DDD, and a time t21, which is the end time of the visit to company DDD. The data on the schedule list for the driver 3B includes the data on the reservation slots for the vehicle 10 from a time t17 to a time t22.

For example, in FIG. 5, a predetermined driver 3 is assumed to be the driver 3A. In this case, the controller 23 associates, among trip data d1 to d8, trip data d1 to d4 that belong to the time period from the time t11 until the time t16, which is the reservation slots for the vehicle 10 of the driver 3A, with the driver 3A. However, if the time period from the time t11 until the time t16 includes the start and end times of the operation of another driver 3, the controller 23 does not associate the trip data d1 to d4 with the driver 3A. In FIG. 5, since the time period from the time t11 until the time t16 does not include the start and end times of the operation of another driver 3, the controller 23 associates the trip data d1 to d4 with the driver 3A.

For example, in FIG. 5, a predetermined driver 3 is assumed to be the driver 3B. In this case, the controller 23 associates, among trip data d1 to d8, trip data d6 to d8 that belong to the time period from the time t17 until the time t22, which is the reservation slots for the vehicle 10 of the driver 3B, with the driver 3B. However, the controller 23 does not need to associate the trip data d6 to d8 with the driver 3B if the time period from the time t17 until the time t22 includes the start and end times of the operation of another driver 3. In FIG. 5, since the time period from the time t17 until the time t22 does not include the start and end times of the operation of another driver 3, the controller 23 associates the trip data d6 to d8 with the driver 3B.

Here, in the process of S7, the controller 23 may estimate whether or not the vehicle 10 will be used for the operation of the driver 3 for the time period of the reservation slots for the vehicle 10 by analyzing the data on the details of the operation of the driver 3. If the controller 23 estimates that the vehicle 10 will not be used for the operation of the driver 3 during the time period of the reservation slots for the vehicle 10, it does not have to associate the trip data belonging to the time period of the reservation slots for the vehicle 10 with the driver 3. In this case, the controller 23 does not need to associate with the driver 3, among the trip data that belongs to the time period of the reservation slots for the vehicle 10, the trip data for the time period from the start time until the end time of the operation that is estimated that the vehicle 10 will not be used.

For example, in FIG. 5, the data on the schedule list for the driver 3A is assumed to include data on the details of the operation, which is an internal meeting. It is also assumed that the start time of the internal meeting is the time t13 and the end time of the internal meeting is the time t14. In this case, the controller 23 estimates that the vehicle 10 will not be used for this operation by analyzing the data on the details of the operation, which is an internal meeting. The controller 23 does not associate the trip data d2 belonging to the time period from the time t13 until the time t14 with the driver 3A among the trip data d1 to d4 belonging to the time period from the time t11 until the time t16, which is the reservation slots for the vehicle 10.

Thus, in the alternative example 2, the controller 23 associates each of the plurality of pieces of the trip data with each of the plurality of drivers 3 based on the data on the schedule list for each of the plurality of drivers 3. Unlike in private practice, schedule lists are often used in an operation to manage the schedule of each of the plurality of drivers 3. This makes it relatively easy for the operation to acquire data on the schedule list for the driver 3. Thus, by using the data on the schedule list for each of the plurality of drivers 3, it is relatively easy to associate each of the plurality of pieces of the trip data for the vehicle 10 with each of the plurality of drivers.

### Alternative Example 3

In an alternative example 3, data on a reservation list for the vehicle 10 is used as data on the usage status of the vehicle 10. The processes from S5 through S7 according to the alternative example 3 are described below.

The process of S5 is performed by the management system 40 instead of the authentication system 30. In the process of S5, the management system 40 transmits the data on the reservation list for the vehicle 10 to the information processing apparatus 20 via the network 2.

In the process of S6, the controller 23 of the information processing apparatus 20 controls the communication interface 21 to receive the data on the reservation list for the vehicle 10 from the management system 40 via the network 2.

In the process of S7, the controller 23 associates each of the plurality of pieces of the trip data generated in the process of S4 with each of the plurality of drivers 3 based on the data on the reservation list for the vehicle 10. As mentioned above, the data on the reservation list for the vehicle 10 includes data on the reservation slots for the vehicle 10 and information on the driver 3 who reserved those slots. Therefore, the controller 23 associates the trip data that belongs to the time period of the reservation slots for the vehicle 10 among the plurality of pieces of the trip data generated in the process of S4 with the driver 3 who reserved the slots.

Thus, in the alternative example 3, the controller 23 associates each of the plurality of pieces of trip data with each of the plurality of drivers 3 based on the data on the reservation list for the vehicle 10. The vehicles 10 used in operations are often managed using a reservation list. This makes it relatively easy for operations to acquire data on the reservation list for the vehicles 10. Thus, by using the data on the reservation list for the vehicle 10, it is relatively easy to associate each of the plurality of pieces of the trip data for the vehicle 10 with each of the plurality of drivers.

### Alternative Example 4

In an alternative example 4, the data on the usage status of the vehicle 10 includes first, second, and third data. The first data includes the driving operation start time for each of the plurality of drivers 3. The first data may include the driving operation start time for each of the plurality of drivers 3 as well as the driving operation end time for each of the plurality of drivers 3. The second data is the data on the schedule list for each of the plurality of drivers 3. The third data is the data on the reservation list for the vehicle 10. The processes from S5 through S7 according to the alternative example 4 are described below.

The process of S5 is executed by the authentication system 30 and the management system 40. The authentication system 30 transmits the first data to the information processing apparatus 20 via the network 2. The management system 40 transmits the second and third data to the information processing apparatus 20 via the network 2.

In the process of S6, the controller 23 of the information processing apparatus 20 controls the communication interface 21 to receive the first data from the authentication system 30 via the network 2. The controller 23 controls the communication interface 21 to receive the second and third data from the management system 40 via the network 2.

In the process of S7, the controller 23 associates each of the plurality of pieces of the trip data generated in the process of S4 with each of the plurality of drivers 3 based on at least any of the first, second, and third data.

For example, the driver 3 may forget to use the alcohol checker or hold his/her employee ID card over the employee ID reader before starting his/her driving operation in the vehicle 10. In this case, the first data does not include the driving operation start time for the driver 3 who forgot to use the alcohol checker, etc., among the plurality of drivers 3. As a result, the accuracy of the first data deteriorates. If the first data does not include the driving operation start time for some of the plurality of drivers 3, the controller 23 may associate each of the plurality of pieces of the trip data with each of the plurality of drivers 3 based on at least any of the second and third data. This configuration allows each of the plurality of pieces of trip data to be accurately associated with each of the plurality of drivers 3. Here, the controller 23 may associate each of the plurality of pieces of the trip data with each of the plurality of drivers 3 based on the larger amount of data among the second and third data. Alternatively, the controller 23 may associate each of the plurality of pieces of the trip data with each of the plurality of drivers 3 based on a combination of the second and third data. When using at least any of the second and third data, the controller 23 associates each of the plurality of pieces of the trip data with each of the plurality of drivers 3, as described above in the alternative example 2 or the alternative example 3 of the process of S7.

For example, some drivers 3 may register a reservation slot on their schedule lists for a longer time period than they themselves plan to use the vehicle 10. In this case, the accuracy of the second and third data deteriorates. Therefore, the controller 23 may associate each of the plurality of pieces of the trip data with each of the plurality of drivers 3 based on the first data, if the first data includes the driving operation start times for all of the plurality of drivers 3. This configuration allows each of the plurality of pieces of trip data to be accurately associated with each of the plurality of drivers 3. In this case, the controller 23 associates each of the plurality of pieces of the trip data with each of the plurality of drivers 3 as described above in the process of S7.

Here, in the process of S7, the controller 23 may associate each of the plurality of pieces of the trip data with each of the plurality of drivers 3 based on at least one of the first and second data or based on at least one of the first and third data. For example, this configuration may be employed when the management system 40 can only transmit one of the second and third data to the information processing apparatus 20 in the process of S5. Alternatively, the controller 23 may associate each of the plurality of pieces of the trip data with each of the plurality of drivers 3 based on at least one of the second and third data. For example, this configuration may be employed when the authentication system 30 cannot transmit the first data to the information processing apparatus 20 in the process of S5.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the embodiment described above, the information processing apparatus 20 is described as acquiring the driving operation start time and driving operation end time for the driver 3 by receiving them from the authentication system 30. However, the information processing apparatus 20 may acquire at least any of the driving operation start time and the driving operation end time for the driver 3 by any method. As another example, the driver 3 may enter his/her own driving operation start time and driving operation end time on a terminal apparatus such as a smartphone. In this case, the controller 23 of the information processing apparatus 20 may acquire the driving operation start time and the driving operation end time for the driver 3 from the terminal apparatus of the driver 3 via the network 2 by receiving them by the communication interface 21.

For example, in the embodiment described above, it is assumed that the vehicle 10 and the information processing apparatus 20 communicate directly with each other via the network 2. However, the vehicle 10 and the information processing apparatus 20 may communicate with each other via other server apparatus.

For example, the information processing apparatus 20 may be used to provide Mobility as a Service (MaaS), a service that leverages mobility. For example, the processing steps as illustrated in FIG. 2 may be executed when providing a service (MaaS) using the vehicle 10. In this case, the information processing method according to the processing steps as illustrated in FIG. 2 is an example of a method of providing a service (MaaS) using the vehicle 10.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a controller configured to:
acquire vehicle data including positional information for a vehicle, and data on a usage status of the vehicle in an operation of each of a plurality of drivers;
generate a plurality of pieces of trip data for the vehicle based on the vehicle data, the trip data being data on a travel history of the vehicle from a departure point to a destination; and
associate each of the plurality of pieces of the trip data with each of the plurality of drivers based on the data on the usage status of the vehicle.

2. The information processing apparatus according to claim 1, wherein the controller is configured to:
acquire a driving operation start time for each of the plurality of drivers as the data on the usage status of the vehicle; and
associate one or more pieces of the trip data for a time period from a driving operation start time for a predetermined driver among the plurality of drivers until a driving operation start time for a next driver to the predetermined driver with the predetermined driver.

3. The information processing apparatus according to claim 1, wherein the controller is configured to:
acquire data on a schedule list for each of the plurality of drivers as the data on the usage status of the vehicle; and
associate each of the plurality of pieces of the trip data with each of the plurality of drivers based on the data on the schedule list for each of the plurality of drivers.

4. The information processing apparatus according to claim 1, wherein the controller is configured to:
acquire data on a reservation list for the vehicle as the data on the usage status of the vehicle; and
associate each of the plurality of pieces of the trip data with each of the plurality of drivers based on the data on the reservation list for the vehicle.

5. The information processing apparatus according to claim 1, wherein the controller is configured to acquire first data, second data, and third data as the data on the usage status of the vehicle,
the first data includes a driving operation start time for each of the plurality of drivers,
the second data is data on a schedule list for each of the plurality of drivers,
the third data is data on a reservation list for the vehicle, and
the controller is configured to associate each of the plurality of pieces of the trip data with each of the plurality of drivers based on the acquired first, second, and/or third data.

6. A method, by a processor, for improving travel mobility as a service (MaaS), comprising processing steps executed by the information processing apparatus according to claim 1.
